(19) United States
(12) Patent Application Publication
(10) Pub. No.: US 2026/0156468 A1
(43) Pub. Date: Jun. 4, 2026

(54) Maintaining Subscriber Privacy in Cellular Communication Networks

(71) Applicant: Rakuten Symphony, Inc., Tokyo (JP)

(72) Inventor: Volkan Sevindik, Denver, CO (US)

(21) Appl. No.: 18/552,835

(22) PCT Filed: Aug. 31, 2023
(86) PCT No.: PCT/US2023/073220

§ 371 Date: Sep. 27, 2023

Related U.S. Application Data
(60) Provisional application No. 63/516,680, filed on Jul. 31, 2023.

(51) Int. Cl. H04W 12/08; H04W 8/18; H04W 12/72

(52) U.S. Cl. CPC H04W 12/08; H04W 8/18; H04W 12/72

(57) ABSTRACT

In a cellular communication network including a plurality of subnetworks, a request is received in a first subnetwork for private user data, such as IMSI. A computerized component responds to the request if the requestor is within the first subnetwork or separated from the first subnetwork by a single router. If the requester is separated from the computerized component by a greater number of routers, a response is transmitted to the requester and is encrypted. If the number of routers exceeds a maximum number, the request is blocked. The maximum number may be a function of the size of the cellular communication network and a characteristic size of the plurality of subnetworks.

### RELATED APPLICATIONS

This application claims the benefit of U.S. Provisional Application Ser. No. 63/516,680, filed Jul. 31, 2023, which is hereby incorporated herein by reference in its entirety for all purposes.

### BACKGROUND

### Field of the Invention

This invention relates to the regulating the sharing of subscriber information in a cellular communication network.

### Background of the Invention

A cellular communication network establishes wireless connections to the devices of subscribers. Typically, the subscriber device will establish a wireless connection to a cellphone antenna that is proximate the subscriber device. When placing a call, the subscriber device will transmit the telephone number of the party being called. The cellular communication network therefore has both the location of the subscriber device as well as access to all telephone numbers called by a subscriber. This is sensitive information that is protected by law.

It would be an advancement in the art to block unauthorized access to subscriber information.

### SUMMARY OF THE INVENTION

A cellular communication network includes a plurality of subnetworks and a database executing in a first subnetwork of the plurality of subnetworks, the database storing private user data. A computerized component executes in the first subnetwork of the plurality of subnetworks. The computerized component is configured to receive a request to access the private user data from a requestor and evaluate a number of routers intervening between the requestor and the computerized component. The computerized component determines whether to block or respond to the request based on the number of routers.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a cellular communication network in which subscriber information may be protected in accordance with an embodiment;

FIG. 2 is a process flow diagram of a method for processing request for subscriber information in accordance with an embodiment;

FIG. 3 is a diagram illustrating traversal of sub-networks of a provider network in accordance with an embodiment; and

FIG. 4 is a schematic block diagram of an example computing device suitable for implementing methods in accordance with an embodiment.

### DETAILED DESCRIPTION

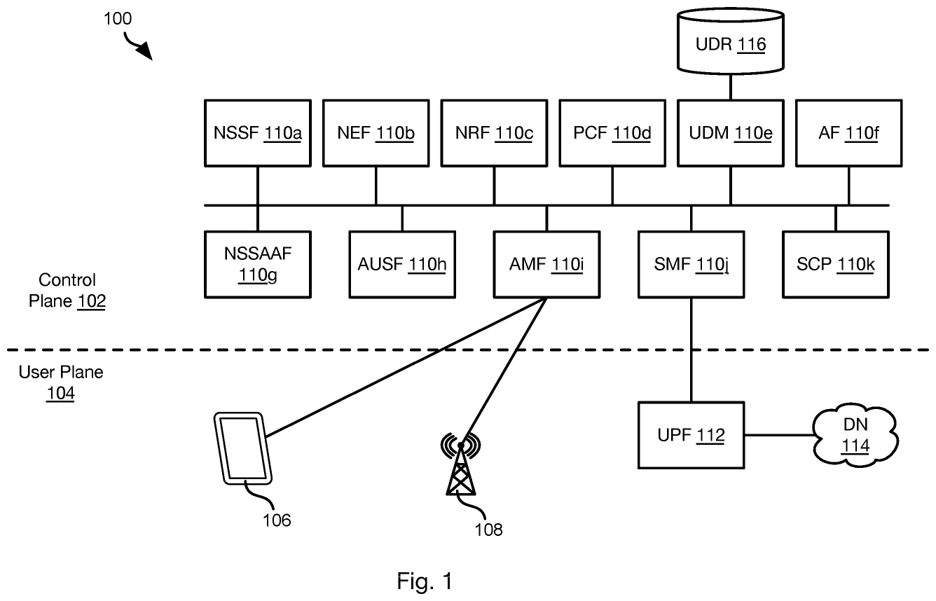

FIG. 1 illustrates an example cellular communication network 100 in which the systems and methods disclosed herein may be used. The cellular communication network 100 may be divided into a control plane 102 and a user plane 104. The control plane 102 manages the establishment of wireless connections to a subscriber device 106 by way of a radio area network (RAN) 108 and the routing of data packets for voice calls, text messages, and data communication. The user plane 104 manages tracking usage by a user device for billing purposes and the storage of user data.

The control plane 102 includes components implementing a cellular communication protocol, such as the 5G cellular communication protocol. For example, the control plane 102 may implement the 5G standard as defined in Technical Release (TR) 21.915, Technical Specification (TS) 22.261, TS 23.501, TS 32.240 TS 38.300 published by the Third Generation Partnership Project (3GPP), all of which are hereby incorporated herein by reference.

For example, the control plane 102 may implement some or all of the following as defined in the 5G standard: network slice selection function (NSSF) 110a, network exposure function (NEF) 110b, network function repository function (NRF) 110c, policy control function (PCF) 110d, unified data management (UDM) 110e, application function (AF) 110f, network slice-specific authentication and authorization function (NSAAF) 110g, authentication server function (AUSF) 110h, access and mobility function (AMF) 110i, session management function (SMF) 110j, and service communication proxy (SCP) 110k.

The user plane 104 may implement the user plane function (UPF) 112. The UPF 112 is a data plane in the 5G standard that manages, among other things, the transmission of data between the subscriber device 106 and a data network 114. The UPF 112 may interface with the SMF 110j to authenticate subscribers attempting to access the data network 114 from a subscriber device 106.

As noted above, the cellular communication network 100 may utilize sensitive subscriber information, such as the identity of a user associated with a particular telephone number, which is known as the international mobile subscriber identification (IMSI). The IMSI of subscribers is protected by law and therefore access thereto is carefully monitored and controlled. In the illustrated cellular communication network 100, the IMSIs of subscribers are stored in a database known as the user data records (UDR) 116. The UDR may be accessed by way of the UDM 110e. The IMSI of a subscriber may include such information as whether the subscriber is prepaid, postpaid, roaming, or other type of subscribers. During ordinary operation, the IMSI of a subscriber may be shared with other servers in a provider network.

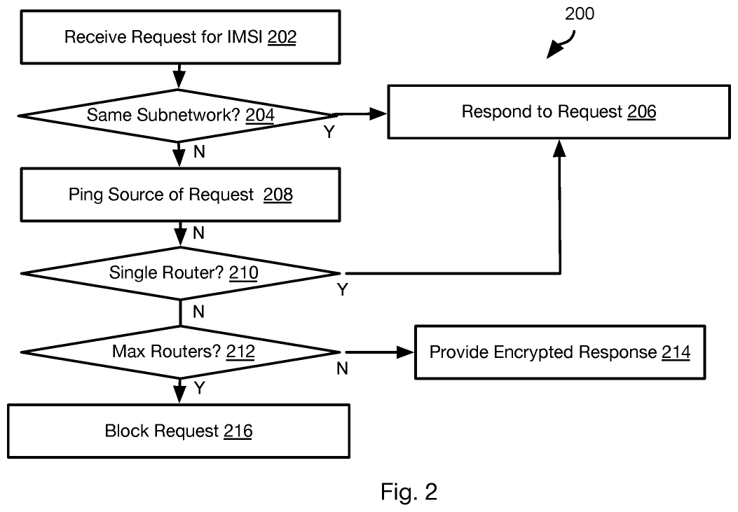

Referring to FIG. 2, unauthorized actors may attempt to access servers of a provider network to direct traffic to an IP address that seems legitimate rather that accessing the servers directly in order to appear normal and avoid detection. This type of unauthorized access is particularly dangerous and hard to detect.

FIG. 2 illustrates a method 200 for preventing unauthorized access to IMSI. The method 200 is described below as being performed by a computerized component including some or all of the attributes of the computing device 400 described below. The computerized component by be the UDR 116, the UDM 110e, the UPF 112, or other component in the control plane 102 or user plane 104, including a component other than those illustrated in FIG. 1.

The method 200 is described below with respect to controlling access to IMSI. It shall be understood that other subscriber data, such as call logs listing phone numbers for calls made and received by a subscriber device 106, payload data sent and received by the subscriber device 106 over the data network 114, or other subscriber data may be controlled according to the method 200 in a like manner.

The method 200 includes receiving 202 a request for IMSI. The request may include, for example, a subscriber telephone number, account number, or other identifier. The request may be for information such as a name, address, demographic data, or other information.

The method 200 includes, in response to the request, evaluating 204 whether a source of the request is in a same subnetwork as the UDR 116. For example, one or more packets conveying the request may be evaluated, particularly the source address field in one or more packets. Step 204 may include evaluating whether the source address corresponds to a subnet mask, domain, or other representation of the subnetwork including the UDR 116.

If the source of the request is found to be in the same subnetwork as the UDR 116, the method 200 may include responding 206 to the request. Responding to the request may include retrieving data from an entry from the UDR 116, such as data from an entry including the subscriber telephone number, account number, or other identifier included in the request. The data from the entry may then be transmitted to the source of the request, such as to the source address of packets constituting the request.

If the source of the request is not found to be in the same network as the UDR 116, the method 200 may include pinging 208 the source of the request. Pinging 208 may include using a function as defined in the transmission control protocol (TCP) and internet protocol (IP), such as the VFYTCPCNN command. Pinging 208 may include using a network tool provided by the operating system executing the UDR 116, such as “ping” function provided by UNIX, LINUX, WINDOWS, MACOS, and other operating systems. Pinging 208 may include transmitting a query (e.g., network packet) to the source of the request and receiving a response. The response may include one or more parameters describing the network path traversed by the query and the response. The one or more parameters may include a size of the ping packet, the number of ping packets transmitted and received, a number of routers traversed by the query and/or the response, identifiers of subnetworks (e.g., subnet masks) traversed by the query and/or the response, the latency of the query to reach the source of the request and/or the latency of the response to reach the UDR 116. The latency may be in the form of maximum, average, or minimum latency of packets transmitted as part of the query.

The method 200 may include evaluating 210 the response to the ping of step 208. For example, if the response is found at step 210 to indicate that the query and response traversed a single router, the method 200 may include responding 206 to the request. For example, the single router may be a default gateway router between a subnetwork hosting the UDR 116 and the subnetwork hosting the requestor. A single router is an example of a first threshold that may be used at step 210. However, other values may be used, such as no more than two routers, no more than three routers, or a number of thresholds no greater than some other value.

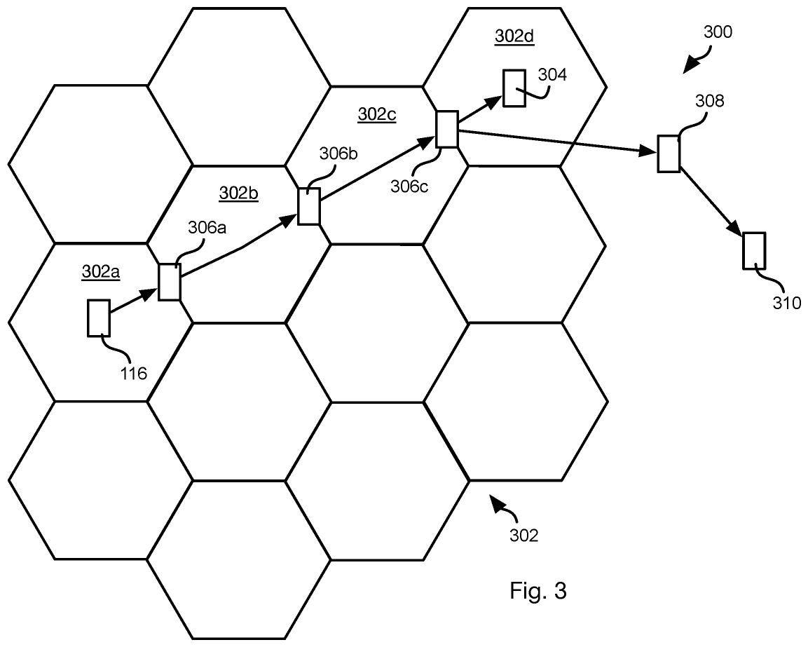

The method 200 may include evaluating 212 whether the number of routers traversed by the query and/or response from the ping of step 208 is greater than second threshold. If not, then the method 200 may include providing 214 an encrypted response to the source of the request. Providing 214 the encrypted response may include encrypting some or all of the data provided to the source of the request as described above with respect to step 206. Step 214 may include establishing an encrypted connection to the source of the request according to any approach known in the art. In some embodiments, step 214 is performed if the number of routers traversed by the query and or response from step 208 is greater than the first threshold (e.g., a single router) and not greater than the second threshold. The second threshold represents a maximum permitted number of routers and may be defined as described below with respect to FIG. 3. The second threshold is greater than the first threshold.

If the number of routers traversed by the query and/or response from the ping of step 208 is greater than the second threshold, the request may be blocked 216. Blocking the request may be accompanied by one or more remediating actions such as transmitting a report to an administrator including the source address of the source of the request. The source address may also be added to a list and all subsequent requests for IMSI from the source address may also be blocked.

FIG. 3 illustrates an example approach for determining the second threshold. A cellular communication network 300 includes a plurality of subnetworks 302. The subnetworks 302 are distributed over a geographic area and have a characteristic size T. The sizes, e.g., diameters, of the subnetworks 302 may be generally the same, such as within 5, 10, 15, or 20 percent of an average diameter of the subnetworks 302. The characteristic size T as used herein may be set to be the average diameter of the subnetworks 302, the maximum diameter of the subnetworks 302, or some other value. For a network 300 covering an area with a size, e.g., diameter, of W, the number of subnetworks 302 will therefore be approximately equal to W/T. The size W may be defined as the maximum dimension of a geographic area covered by the network 300, an average distance from a centroid of the geographic area for a set of points along the perimeter of the geographic area, or some other measure of the size of the geometric area. The second threshold may be set to be equal to W/T or some scaled version thereof, such as W/T multiplied by a scaling factor such as a value between 0.8 and 1.2, between 0.9 and 1.1, or between 0.95 and 1.05.

For example, pinging 208 may include transmitting a query from the UDR 116 in subnetwork 302a to a requestor 304 in the subnetwork 302d. The computerized component implementing the method 200 may be located in the subnetwork 302a including the UDR 116. The query traverses routers 306a, 306b, 306c in the illustrated. For example, the routers 306a, 306b, 306c may be gateway routers between subnetworks 302a, 302b, 302c, and 302d. For the illustrated network 300, the second threshold may be set to three such that a request from requestor 304 may be responded to with an encrypted response as described above with respect to step 214.

In contrast, a query that passes through an additional router 308 to reach a requestor 310 that is external to the network 300 will have passed through four routers and therefore will be greater than the second threshold. The request from the requestor 310 will therefore be blocked as described above with respect to step 216.

Various modification of the approach described above with respect to FIGS. 1 to 3 may be used. The approach described herein may be used in combination with other approaches for detecting unauthorized access, such as that disclosed in U.S. Pat. No. 8,582,567, which is hereby incorporated herein by reference in its entirety. U.S. Pat. No. 8,582,567 describes an approach for preventing IMSI spoofing stealth attacks. U.S. Pat. No. 8,582,567 discloses an algorithm that is aware of state machine of a network, such as an IP multimedia subsystem (IMS) and detects call-by-call anomalies in order to detect Man-In-the-Middle attacks. For example, the algorithm may be configured with alert thresholds and timeouts. The alert thresholds may be evaluated with respect to counters for some or all of a number of spoofed messages detected per secured entity, and number of ping-back messages sent to each distinct destination.

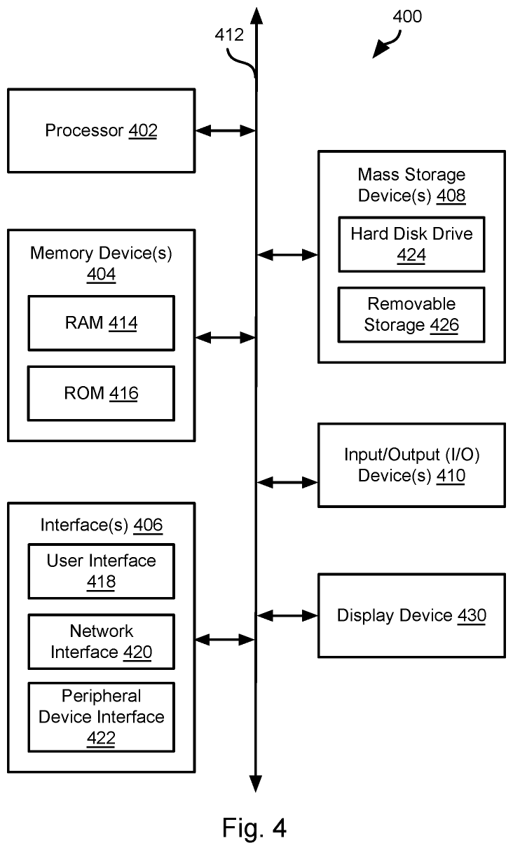

FIG. 4 is a block diagram illustrating an example computing device 400. Computing device 400 may be used to perform various procedures, such as those discussed herein.

Computing device 400 includes one or more processor(s) 402, one or more memory device(s) 404, one or more interface(s) 406, one or more mass storage device(s) 408, one or more Input/output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, I/O device(s) 410, and display device 430 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A cellular communication network comprising:
a plurality of subnetworks;
a database executing in a first subnetwork of the plurality of subnetworks, the database storing private subscriber data; and
a computerized component executing in the first subnetwork of the plurality of subnetworks, the computerized component configured to:
receive a request to access the private subscriber data from a requestor;
evaluate a number of routers intervening between the requestor and the computerized component; and
determine whether to block or respond to the request based on the number of routers.

2. The cellular communication network of claim 1, wherein the database is a user database record (UDR).

3. The cellular communication network of claim 1, wherein the computerized component is a 5G unified data management (UDM) component.

4. The cellular communication network of claim 1, wherein the private subscriber data is International Mobile Subscriber Identification (IMSI) information.

5. The cellular communication network of claim 1, wherein the computerized component is configured determine whether to block or respond to the request based on the number of routers by:
if the request is from a source address within the first subnetwork, responding to the request.

6. The cellular communication network of claim 5, wherein the computerized component is further configured to:
if the request is not from the source address within the first subnetwork, transmit a query to the requestor; and
obtain the number of routers from a response to the query.

7. The cellular communication network of claim 6, wherein the query is a ping.

8. The cellular communication network of claim 1, wherein the computerized component is configured to:
if the number of routers is less than or equal to a first threshold, transmit a response to the request to the requestor.

9. The cellular communication network of claim 8, wherein the first threshold is 1.

10. The cellular communication network of claim 8, wherein the computerized component is further configured to:
if the number of routers is less than or equal to a second threshold that is greater than the first threshold, transmitting an encrypted response to request to the requestor.

11. The cellular communication network of claim 10, wherein the computerized component is further configured to:
if the number of routers is greater than the second threshold blocking the request.

12. The cellular communication network of claim 11, wherein the second threshold is a function of a size of the cellular communication network.

13. The cellular communication network of claim 12, wherein the second threshold is a function of a ratio of a size of the cellular communication network and a characteristic size of the plurality of subnetworks.

14. A method comprising:
receiving, by a computerized component in a first subnetwork of a plurality of subnetworks in a cellular communication network, a request for private subscriber data for a subscriber of the cellular communication network;
determining, by the computerized component, that a source of the request is not in the first subnetwork;
in response to determining that the source of the request is not in the first subnetwork performing, by the computerized component:
transmitting a query to the source of the request;
receiving a response to the query from the source of the request;
evaluating a number of routers traversed by the query indicated by the response;
determining that the number of routers exceeds a threshold; and
in response to determining that the number of routers exceeds the threshold, blocking the request.

15. The method of claim 14, wherein the private subscriber data is International Mobile Subscriber Identification (IMSI) information and the computerized component is a 5G unified data management (UDM) component.

16. The method of claim 14, wherein the query is a ping.

17. The method of claim 14, wherein the threshold is a function of a size of the cellular communication network.

18. The method of claim 14, wherein the threshold is a function of a ratio of a size of the cellular communication network and a characteristic size of the plurality of subnetworks.

19. The method of claim 14, wherein the threshold is a first threshold, the method further comprising:
determining (a) that the number of routers exceeds the first threshold but does not exceed a second threshold that is greater than the first threshold; and
in response to determining (a), transmitting an encrypted response including the private subscriber data to the source of the request.

20. A non-transitory computer-readable medium storing executable that, when executed by one or more processing devices, causes the one or more processing devices to perform a method comprising:
receiving, by a computerized component in a first subnetwork of a plurality of subnetworks in a cellular communication network, a request for private subscriber data for a subscriber of the cellular communication network;
determining, by the computerized component, that a source of the request is not in the first subnetwork;
in response to determining that the source of the request is not in the first subnetwork performing, by the computerized component:
transmitting a query to the source of the request;
receiving a response to the query from the source of the request;
evaluating a number of routers traversed by the query indicated by the response;
determining that the number of routers exceeds a threshold; and
in response to determining that the number of routers exceeds the threshold, blocking the request.
